(19) United States
(12) Patent Application Publication
(10) Pub. No.: US 2013/0077084 A1
(43) Pub. Date: Mar. 28, 2013

(54) OBJECT CHARACTERISTIC MEASURING SYSTEM

(71) Applicant: Tze-An LIU, Hsinchu City (TW)

(72) Inventor: Tze-An LIU, Hsinchu City (TW)

(73) Assignee: INDUSTRIAL TECHNOLOGY RESEARCH INSTITUTE, Hsinchu (TW)

(21) Appl. No.: 13/359,585

(22) Filed: Jan. 27, 2012

(30) Foreign Application Priority Data
Sep. 28, 2011 (TW) 100135073

(51) Int. Cl. G01C 3/08

(52) U.S. Cl. 356/5.03

(57) ABSTRACT

An object characteristic measuring system, used to measure semiconductor thin film characteristics, is formed by a dual-optical comb absolute distance measuring device and a terahertz (THz) wave time-domain measuring device. The dual-optical comb absolute distance measuring device is formed by two laser modules, for determining a first characteristic of an object to be measured through laser pulses emitted by the two laser modules. The THz wave time-domain measuring device is used to emit a THz wave, so as to measure a second characteristic of the object to be measured.

### CROSS-REFERENCE TO RELATED APPLICATIONS

This non-provisional application claims priority under 35 U.S.C. §119(a) on Patent Application No(s). 100135073 filed in Taiwan, R.O.C. on Sep. 28, 2011, the entire contents of which are hereby incorporated by reference.

### BACKGROUND

1. Technical Field

The present disclosure relates to an object characteristic measuring system, for measuring semiconductor thin film characteristics, and more particularly to a semiconductor thin film characteristic measuring method and a device thereof, capable of accurately measuring thin film characteristic parameters by using a dual-optical comb absolute distance measuring system and a terahertz (THz) wave time-domain measuring system.

2. Related Art

The so-called THz wave band refers to the electromagnetic spectrum with the frequency near 10¹² Hz, and includes a section of an electromagnetic spectrum from a part of millimeter wave band (˜0.1 THz) to the far infrared region (˜25 THz). In condensed matter physics research, the THz wave band is a quite important spectrum. The reason is that the THz wave band includes many important energy levels determining material characteristics, for example, binding energy of an acceptor, a donor, and an exciton in the semiconductor, optical phonon, superconducting energy gap, and a Landau energy spectrum under effects of the magnetic field fall within the wave band.

THz wave spectroscopic techniques have a THz time-domain spectroscopy (THz-TDS) technique, which is quite suitable for imaging and measuring a sample. In the semiconductor element industry, physical quantities related to photoelectric characteristics of the semiconductor material for manufacturing the element, for example, refractive index, absorptivity, dielectric constant, carrier density, mobility, resistance coefficient, and electric conductivity, are important elements for determining the performances of the semiconductor element. Therefore, recently, the THz wave time-domain measuring technique is used to detect the optical and electrical characteristics of the semiconductor element.

An electrical characteristics evaluation apparatus, in which pulse light in the THz frequency domain (THz pulse light) is emitted onto a semiconductor material, the pulse light having been transmitted through or having been reflected is detected, a spectral transmittance or a spectral reflectance (that is, spectral characteristic) is respectively calculated, such that the electrical characteristic, parameters of the semiconductor material can be measured and evaluated.

For a dual laser THz wave measuring system, the system provides the technical means, in which a dual laser module is coupled to a pair of photoconductive switches to generate signals in the range of frequencies from 100 gigahertz (GHz) to over 2 THz, the signal is propagated through an object or irradiates the object and is reflected by the object, then a detector acquires spectral information from the detected signals and uses a multi-spectral homodyne process to generate an electrical signal representative of electrical characteristics of the object. The photoconductive switches are driven by laser beams from the dual laser module.

Further, there are a method and an apparatus for measuring a THz time-domain spectrum. The method includes the steps of: generating a first pulse laser beam from a first femtosecond laser device at a preset repetition frequency to generate THz pulses; generating a second pulse laser beam from a second femtosecond laser device at the repetition frequency; measuring electric field intensities of the THz pulses at respective phase differences between the first pulse laser beam and the second pulse laser beam; and obtaining a THz time-domain spectrum by performing Fourier transformation of data representative of the electric field intensities.

In the material (for example, thin film) measuring system of the THz wave time-domain, the waveform variation of having the thin film and not having the thin film (pure substrate) is measured by using a time of flight method of the THz pulse, and the characteristics, for example, refractive index, carrier mobility, and electric conductivity, of the thin film sample may be measured and derived in a non contact manner or a non destructive manner. However, if the substrate of the sample is metal or highly-doped materials, the resistance value of the substrate is too small, the THz wave cannot transmit through the entire material, so that a reflection-type measuring method needs to be used. However, in a normal reflection-type THz wave time-domain measuring system, when the sample is moved, for example, after the thin film is measured, the sample is moved to the substrate, the zero point at a reference time of the surface of the sample cannot be determined.

### SUMMARY

The present disclosure provides an object characteristic measuring system, for measuring semiconductor thin film characteristics, capable of accurately deciding a position of a zero point at a reference time of a surface of a sample by using a dual-optical comb absolute distance measuring system and a THz wave time-domain measuring system, and correcting a time error resulting from movement of the sample by adjusting a spatial position of the sample and inclining the sample, so as to accurately measure real waveforms, thereby deriving thin film characteristic parameters.

An object characteristic measuring system provided according to an embodiment comprises a dual-optical comb absolute distance measuring device and a THz wave time-domain measuring device. The dual-optical comb absolute distance measuring system generates a first laser pulse series and a second laser pulse series, in which the second laser pulse series is used to irradiate a reference plane and an object to be measured, and generate a reflected laser pulse train, so as to sample the reflected laser pulse train according to the first laser pulse series, thereby accordingly determining a first characteristic of the object to be measured. The THz wave time-domain measuring system emits a THz wave in response to the second laser pulse series, in which the THz wave is capable of being emitted to the object to be measured and is reflected, so as to sample the reflected THz wave according to the first laser pulse series, thereby determining a second characteristic of the object to be measured.

An object characteristic measuring method provided according to an embodiment comprises generating a first laser pulse series and a second laser pulse series, in which the second laser pulse series is used to irradiate a reference plane and an object to be measured, so as to sample the reflected second laser pulse series according to the first laser pulse series, thereby accordingly determining a first characteristic of the object to be measured; and emitting a THz wave in response to the second laser pulse series, in which the THz wave is capable of being emitted to the object to be measured and is reflected, so as to sample the reflected THz wave according to the first laser pulse series, thereby determining a second characteristic of the object to be measured. The object characteristic measuring system provided according to the embodiment is capable of accurately deciding a position of a zero point at a reference time of a surface of a sample, for example, the above-mentioned first characteristic, by using a dual-optical comb absolute distance measuring system and a THz wave time-domain measuring system, and correcting a time error resulting from movement of the sample by adjusting a spatial position of the sample and inclining the sample, so as to accurately measure real waveforms, thereby deriving thin film characteristic parameters, for example, the above-mentioned second characteristic. The dual laser pulse train asynchronous sampling method provided in the present disclosure used to determine and control the position of the sample is not taught in the related art. In addition, a machine table is moved and adjusted by a feedback control system and the absolute distance measuring system, so as to further ensure that the zero position is the same.

For purposes of summarizing, some aspects, advantages and features of some embodiments of the invention have been described in this summary. Not necessarily all of (or any of) these summarized aspects, advantages or features will be embodied in any particular embodiment of the invention. Some of these summarized aspects, advantages and features and other aspects, advantages and features may become more fully apparent from the following detailed description and the appended claims.

### BRIEF DESCRIPTION OF THE DRAWINGS

The present disclosure will become more fully understood from the detailed description given herein below for illustration only, and thus are not limitative of the present disclosure, and wherein:

FIG. 1 is a schematic structural view of an embodiment of a THz wave time-domain measuring system according to the present disclosure;

FIG. 2 is a schematic structural view of another embodiment of a THz wave time-domain measuring system according to the present disclosure;

FIG. 3 is a measurement diagram of repetition rates of a first laser pulse series and a second laser pulse series in testing;

FIG. 4 is a spectrogram of the first laser pulse series and the second laser pulse series of FIG. 3;

FIG. 5 shows actually measured absolute distances;

FIG. 6 shows accuracy of measurement through dual-optical comb distance measuring in the present disclosure;

FIG. 7 is a flow chart of an object characteristic measuring method according to the present disclosure;

FIG. 8 is a flow chart of determining a first characteristic of an object to be measured in the object characteristic measuring method according to the present disclosure; and

FIG. 9 is a flow chart of determining a second characteristic of an object to be measured in the object characteristic measuring method according to the present disclosure.

### DETAILED DESCRIPTION

The detailed features and advantages of the present disclosure are described below in great detail through the following embodiments, and the content of the detailed description is sufficient for persons skilled in the art to understand the technical content of the present disclosure and to implement the present disclosure there accordingly. Based upon the content of the specification, the claims, and the drawings, persons skilled in the art can easily understand the relevant objectives and advantages of the present disclosure. The viewpoints of the present disclosure are further described in detail in the following embodiments, but the scope of the present disclosure is not limited to any viewpoint.

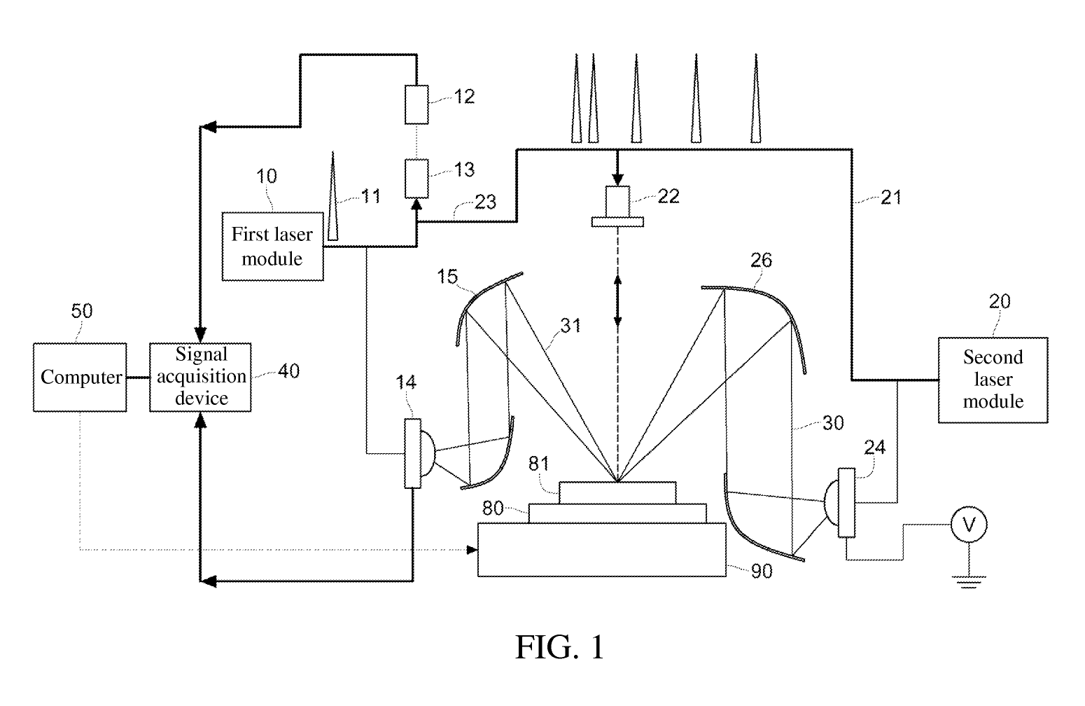

FIG. 1 is a systematic architecture view of a THz reflection-type measuring system according to the present disclosure. Referring to FIG. 1, in addition to performing reflection-type measuring, the THz reflection-type measuring system according to the present disclosure performs transmittance type measuring. In order to ensure consistency of the zero point at a reference time, the present disclosure provides a THz reflection-type measuring system, which is particularly suitable for measuring characteristics, for example, porosity and carrier mobility, of a TiO₂ layer of a dye sensitized solar panel.

As shown in FIG. 1, the THz reflection-type measuring system according to the present disclosure comprises two parts, one part is a dual-optical comb absolute distance measuring system, and the other part is a THz wave time-domain measuring system, in which individual constitution and operation are described in detail in the following paragraphs. In the dual-optical comb absolute distance measuring system, the zero position is ensured to be the same through moving and adjusting of a machine table. The dual-optical comb absolute distance measuring system generates a first laser pulse series and a second laser pulse series, in which the second laser pulse series is used to irradiate a reference plane and an object to be measured, so as to sample the reflected second laser pulse series according to the first laser pulse series, thereby accordingly determining a first characteristic of the object to be measured. The first characteristic comprises a zero point at a reference time. The THz wave time-domain measuring system emits a THz wave in response to the second laser pulse series, in which the THz wave is capable of being emitted to the object to be measured and is reflected, so as to sample the reflected THz wave according to the first laser pulse series, thereby determining a second characteristic of the object to be measured. In this embodiment, a distance between the reference plane and a surface of the sample is used as a basis to define the zero point at a reference time, and the reference plane is a reference plane 27 of a first optical coupler 22 in FIG. 1. In another embodiment, the reference plane may be a reflective surface of the first optical coupler 22, or may be a reflective surface resulting from an optical flat panel additionally placed on the back.

The dual-optical comb absolute distance measuring system comprises a first laser module 10 and a second laser module 20, the first laser module 10 is used to generate a first laser pulse series 11, and the second laser module 20 is used to generate a second laser pulse series 21. Here, defining through the trains refers to that the laser pulse train may be continuously generated and a train state is formed. The first laser pulse series 11 has a first repetition rate, the second laser pulse series 21 has a second repetition rate, and the first repetition rate and the second repetition rate are different, and have a slight difference, from 1 hertz (Hz) to 1 megahertz (MHz), usually several kilohertz (kHz), for serving as asynchronous sampling.

The second laser pulse series 21 generated by the second laser module 20 is emitted to a surface of an object to be measured 81 through the first optical coupler 22. The object to be measured 81 is an object having a thin film or a semiconductor thin film. In an application aspect, the object to be measured 81 is grown on a substrate 80. The substrate 80 is usually a semiconductor substrate with silicon being main composition. Usually, during a manufacturing process, the object to be measured 81 is placed on a machine table 90, and generally the machine table 90 may be controlled to move and incline. In another embodiment, the machine table 90 may be controlled to move and incline in a feedback control manner, so as to accurately determine the position zero of the object to be measured, thereby improving measuring accuracy.

As described above, after being emitted to the object to be measured 81 or the substrate 80 through the first optical coupler 22, the second laser pulse series 21 generated by the second laser module 20 may be reflected, and the reflected second laser pulse series 21 may be transmitted by the first optical coupler 22. A second optical coupler 13 couples the first laser pulse series 11 and the second laser pulse series 23 reflected from the end surface (that is, the above-mentioned reference plane 27) of the first optical coupler 22 and the object to be measured 81, so as to output a time-domain expanded coupled laser pulse train resulting from asynchronous sampling. The optical detector 12 is used to detect the asynchronously sampled laser pulse train, and the laser pulse train received by the optical detector 12 is received and measured by a signal acquisition device 40 (for example, an analogue to digital signal acquisition card). Time when the optical detector 12 receives the second laser pulse series 21 reflected from the end surface of the first optical coupler 22 is recorded as first time, and time when the optical detector 12 receives the second laser pulse series 21 reflected from the object to be measured 81 is recorded as second time. The first time and the second time may have a time difference, the time difference is used as a reference, when the machine table 90 moves the sample, a computer 50 reads the time difference at any time, and compares the time difference with the reference value (for example, perform subtraction on the time difference and the reference value), the difference value is output as a voltage signal through the computer, and the voltage signal may be related to the time difference, for example, directly related to the time difference, such that a three-axial knob on the machine table 90 may be controlled through the voltage signal, thereby achieving the objective of feedback controlling the time difference.

For example, a processing module calculates the distance of the zero, for example, 5 centimeters (cm), and also calculates a distance of moving to a position point to be measured, for example, 5.1 cm−film thickness 0.002 cm=5.098 cm. 0.098 cm is obtained after subtraction is performed. Finally, a program controls the output voltage to push a voltage controlled displacement device. In an embodiment, the voltage controlled displacement device may be a moving table or a trimming knob of a stepping motor installed on three axes being x, y, and z. The first laser module 10 and/or the second laser module 20 may be a frequency stabilized or non-frequency stabilized laser module, so as to generate a frequency stabilized or non-frequency stabilized laser pulse train.

The THz wave time-domain measuring system is described in the following. The THz wave time-domain measuring system is mainly formed by a THz wave radiating element 24 and a THz wave receiving element 14. The THz wave radiating element 24 generates a THz wave 30 in response to the second laser pulse series 21 generated by the second laser module 20. Through proper configuration, for example, a first reflective device 26 is configured, the THz wave 30 may be properly emitted to the object to be measured 81, so as to measure optical and electrical characteristics of the object to be measured 81. For the reflected THz wave after the THz wave 30 is emitted to the object to be measured 81, similarly, through proper configuration, for example, a second reflective device 15 is configured, the THz wave 30 reflected from the object to be measured 81 may be properly received by the THz wave receiving element 14. After the THz wave receiving element 14 receives the THz wave 31 reflected from the object to be measured 81, a signal acquisition device receives the THz wave 31 and performs measuring.

The THz wave has good thin film transmittance, such that if the object to be measured 81 has a TiO₂ thin film, the THz wave may transmit through the TiO₂ thin film and is reflected back, so as to measure the thin film characteristics, for example, a film thickness, through transmittance waveforms.

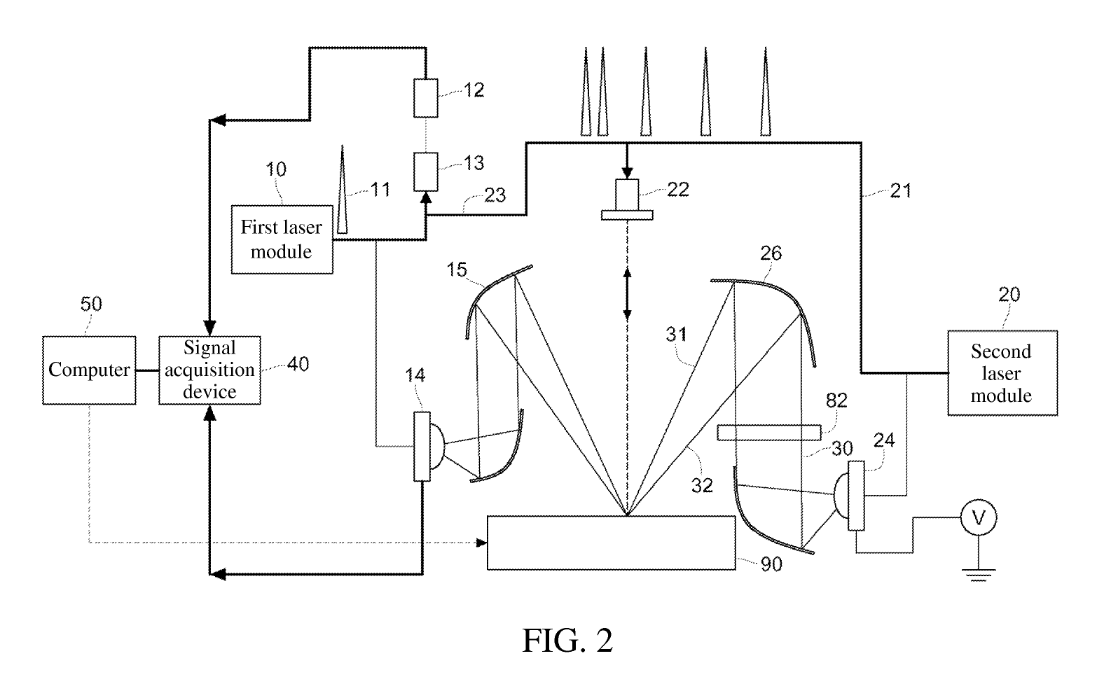

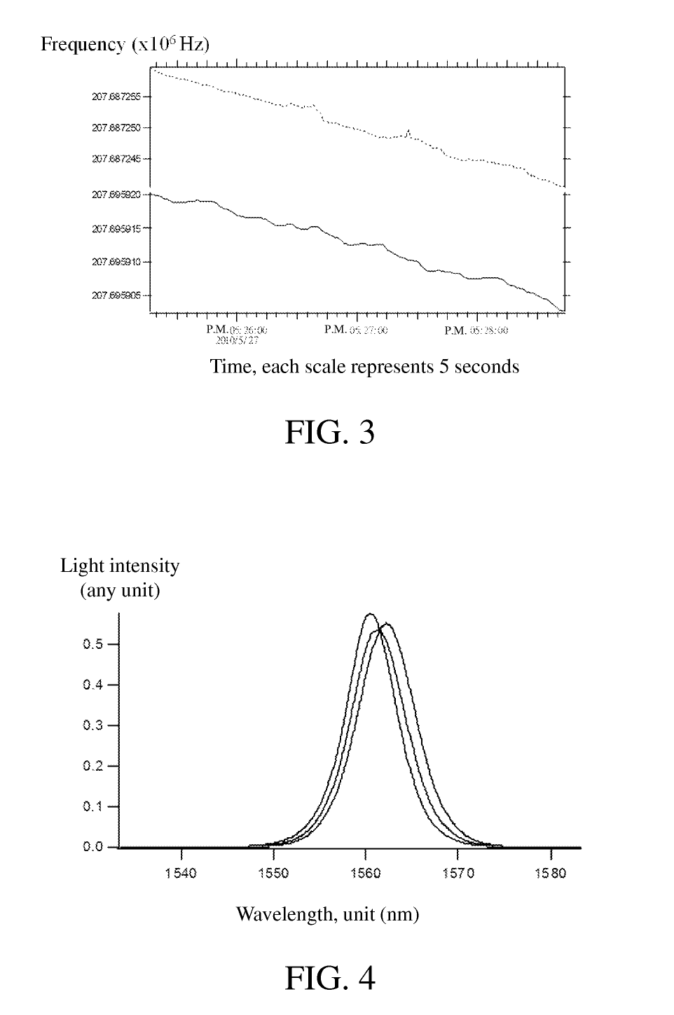

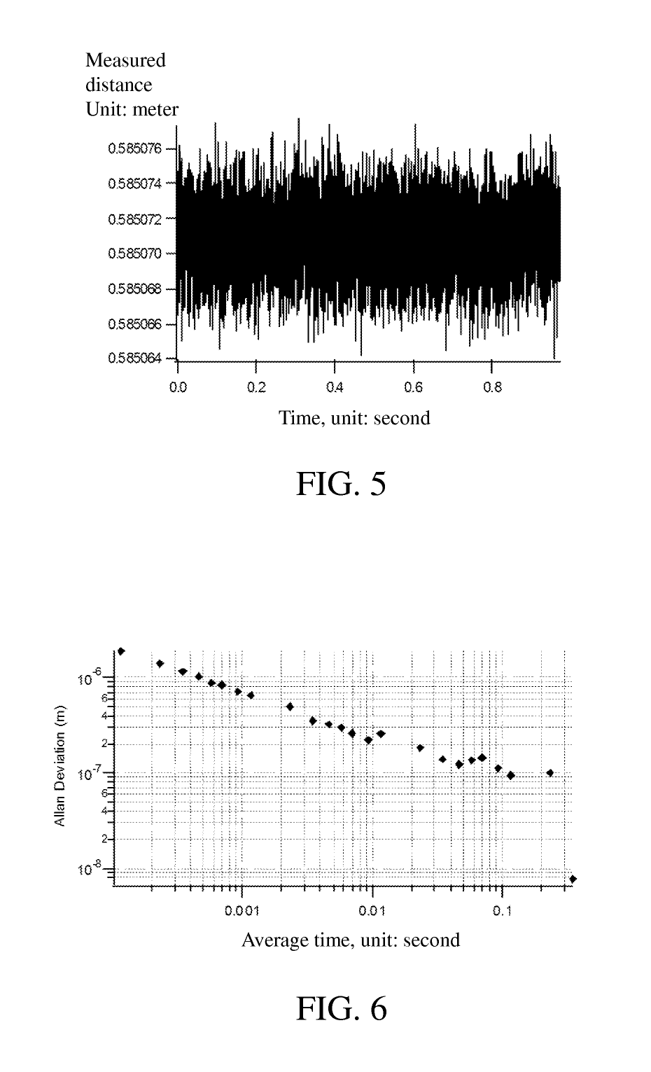

FIG. 2 shows another application embodiment of a THz reflection-type measuring system according to the present disclosure. Referring to FIG. 2, an object to be measured 82 is measured in a transmittance manner. In the embodiment of FIG. 2, the main architecture is the same as the above-mentioned, so description is omitted. The difference is that in this embodiment, the THz wave time-domain measuring system performs measuring in the transmittance manner by using a THz wave. Similar to the above embodiment, the THz wave radiating element 24 generates a THz wave 30 in response to the second laser pulse series 21 generated by the second laser module 20. Through proper configuration, for example, a reflective device 26 is configured, the THz wave transmitting through the object to be measured 82 may be properly emitted to the machine table 90. For the reflected THz wave after the THz wave 30 is emitted to the machine table 90, similarly, through proper configuration, for example, a reflective device 15 is configured, the THz wave 31 reflected from the machine table 90 may be properly received by the THz wave receiving element 14. After the THz wave receiving element 14 receives the THz wave 31 reflected from the object to be measured 82, a signal acquisition device receives the THz wave 31 and performs measuring. Through verification of experiments, the embodiment of the present disclosure may really improve the measuring accuracy. FIG. 3 shows variation of the repetition rates of two lasers with the time recorded by a microwave frequency counter, FIG. 4 shows a spectrogram of two lasers measured by a spectrometer, FIG. 5 shows variation of the distance (fixed) with the time, in which the distance is converted from the time difference of reflecting from the reference plane and reflecting from the surface to be measured, measured and sampled by a rapid signal acquisition card (GaGe Scope, with a sampling rate of 200 MS/s), and run-out of a longitudinal axis value may be considered as a system error, and FIG. 6 is an error view obtained by analyzing FIG. 5 through Igor software. Referring to FIG. 3, FIG. 3 shows the repetition rates of the first laser pulse series and the second laser pulse series, the dash line represents the first laser pulse series of the above embodiment, and the real line represents the second laser pulse series of the above embodiment. The spectrums are as shown in FIG. 4, which indicate that the wavelengths have a certain degree of consistency and the waveform may be used as the waveform sample on the time-domain. The actually measured absolute distances are as shown in FIG. 5, and the improvement of the accuracy may be seen from FIG. 6, which shows that the accuracy is really extremely high. In FIG. 6, the measured distance is used as average time length during Allan deviation, and the longitudinal axis represents Allan deviation (with a unit of meter) of the measured distance.

An Allan deviation is a square root of an Allan variance, and is represented in the following.

σ_{y}(τ)=\sqrt{σ_{y}²(τ)}

The Allan variance is defined as σ_{y}²(τ)= [symbol] σ_{y}²(2, τ, τ) [symbol] .

For sake of convenience, it may be marked in the following.

$${σ}_{y}^{2} ( τ ) = \frac{1}{2} 〈 {( {\overline{y}}_{n + 1} - {\overline{y}}_{n} )}^{2} 〉 = \frac{1}{2 {τ}^{2}} 〈 {( {x}_{n + 2} - 2 {x}_{n + 1} + {x}_{n} )}^{2} 〉$$

τ is viewing time, y̅ₙ is an n^{th} fractional frequency average in the viewing time τ, a fractional frequency y(t) is a normalized delta obtained from a nominal frequency vₙ, such that y(t) is represented as:

$$y ( t ) = \frac{v ( t ) - {v}_{n}}{{v}_{n}} = \frac{v ( t )}{{v}_{n}} - 1.$$

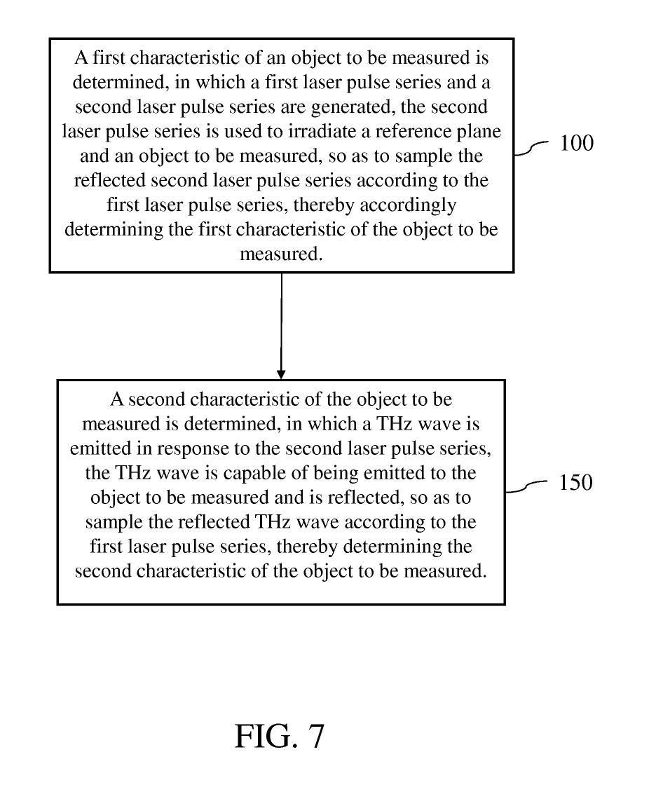

FIG. 7 is a flow chart of an object characteristic measuring method according to the present disclosure. Firstly, a dual-optical comb absolute distance measuring system determines a first characteristic of an object to be measured (step 100), and a THz wave time-domain measuring system determines a second characteristic of the object to be measured (step 150). In the step of determining the first characteristic of the object to be measured, a first laser pulse series and a second laser pulse series are generated, in which the second laser pulse series is used to irradiate a reference plane and an object to be measured, so as to sample the reflected second laser pulse series according to the first laser pulse series, thereby accordingly determining the first characteristic of the object to be measured. The first laser pulse series has a first repetition rate, the second laser pulse series has a second repetition rate, and the first repetition rate and the second repetition rate are different. In the step of determining the second characteristic of the object to be measured, a THz wave is emitted in response to the second laser pulse series, in which the THz wave is capable of being emitted to the object to be measured and is reflected, so as to sample the reflected THz wave according to the first laser pulse series, thereby determining the second characteristic of the object to be measured.

Similar to the above-mentioned object characteristic measuring system, the first characteristic comprises a zero point at a reference time and a corresponding distance between the reference plane and a surface of the object to be measured.

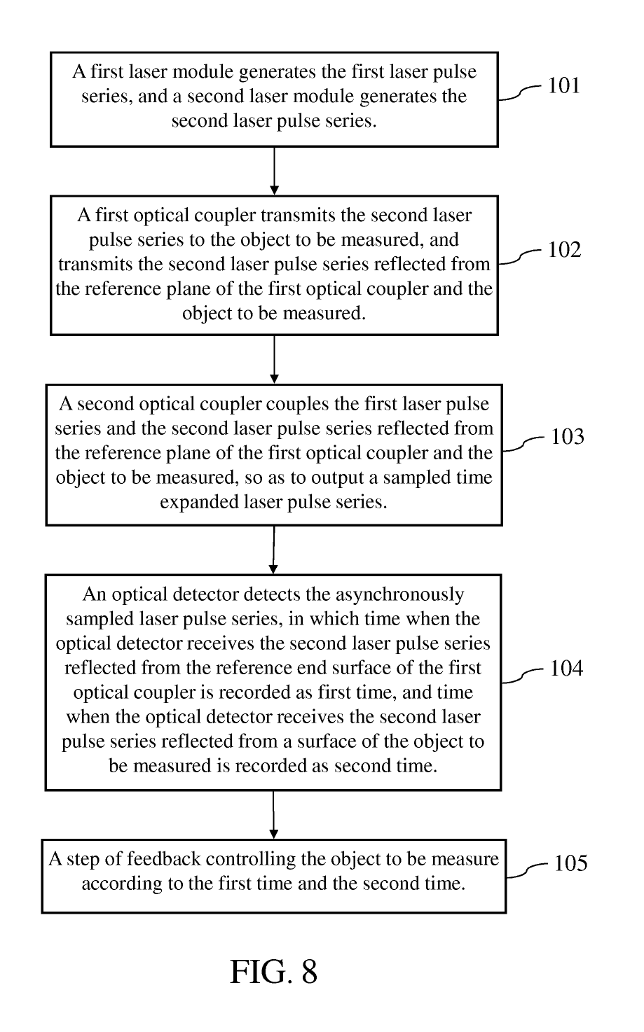

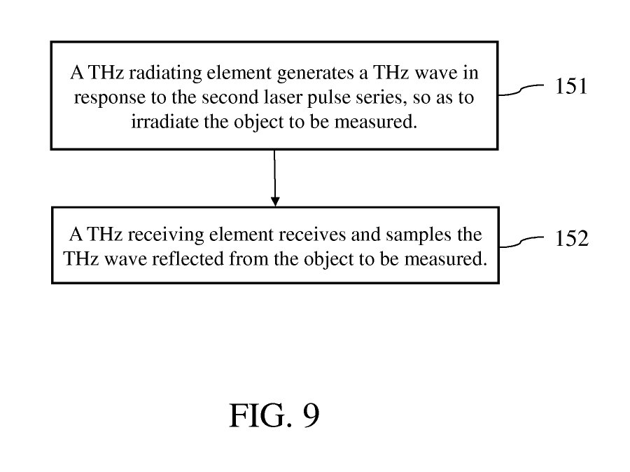

Similar to the above-mentioned object characteristic measuring system, referring to FIG. 8, in the step of determining the first characteristic of the object to be measured, a first laser module generates the first laser pulse series, and a second laser module generates the second laser pulse series (step 101), in which the first laser module and/or the second laser module is a frequency stabilized or non-frequency stabilized laser module. Next, a first optical coupler transmits the second laser pulse series to the object to be measured, and transmits the second laser pulse series reflected from the reference plane of the first optical coupler and the object to be measured (step 102). A second optical coupler couples the first laser pulse series and the second laser pulse series reflected from the reference plane of the first optical coupler and the object to be measured, so as to output a sampled time expanded laser pulse train (step 103). Finally, an optical detector detects the asynchronously sampled laser pulse train (step 104), in which time when the optical detector receives the second laser pulse series reflected from the reference end surface of the first optical coupler is recorded as first time, and time when the optical detector receives the second laser pulse series reflected from a surface of the object to be measured is recorded as second time.

Similar to the above-mentioned object characteristic measuring system, the method further comprises a step of feedback controlling the object to be measure according to the first time and the second time (step 105).

Similar to the above-mentioned object characteristic measuring system, the step of determining the second characteristic of the object to be measured comprises that a THz radiating element generates a THz wave in response to the second laser pulse series, so as to irradiate the object to be measured (step 151); and a THz receiving element receives and samples the THz wave reflected from the object to be measured (step 152). The THz wave is reflected to the object to be measured by a first reflective element, and the THz wave reflected from the object to be measured is reflected to the THz receiving element by two first reflecting elements.

For the ordinary reflection-type THz wave time-domain measuring system, when the sample is moved, for example, after the thin film is measured, the sample is moved to the substrate, the zero point at a reference time of the surface of the sample cannot be determined. The present disclosure provides a method, capable of accurately deciding a position of a zero point at a reference time of a surface of a sample by using a dual-optical comb absolute distance measuring system and a THz wave time-domain measuring system, and correcting a time error resulting from movement of the sample by adjusting a spatial position of the sample and inclining the sample, so as to accurately measure real waveforms, thereby deriving thin film characteristic parameters. The dual laser pulse train asynchronous sampling method provided in the present disclosure used to determine the characteristics and the position of the sample is not taught in the related art.

The measuring system according to the present disclosure is a non destructive type and non contact type physical or electrical planar measuring method during a material manufacturing process. The method may be used for porosity monitoring or real-time manufacturing process monitoring of a carrier mobility and electric conductivity during a manufacturing process of a porous TiO₂ thin film of a dye sensitized solar panel. The substrate of some manufactures is metal, and the thin film parameters are measured through the THz controlled by the dual-optical comb reflection-type distance, such that the manufacturing process quality may be effectively controlled, and the yield is improved. The method may also be used for real-time monitoring of a thin film thickness when some biotechnology companies manufacture artificial hearts.

The present disclosure may be embodied in other specific forms without departing from its spirit or essential characteristics. The described embodiments are to be considered in all respects only as illustrative and not restrictive. The scope of the disclosure is, therefore, indicated by the appended claims rather than by the foregoing description. All changes which come within the meaning and range of equivalency of the claims are to be embraced within their scope.

What is claimed is:

1. An object characteristic measuring system, comprising:
a dual-optical comb absolute distance measuring system, for generating a first laser pulse series and a second laser pulse series, wherein the second laser pulse series is used to irradiate a reference plane and an object to be measured, so as to sample the reflected second laser pulse series according to the first laser pulse series, thereby accordingly determining a first characteristic of the object to be measured; and
a terahertz (THz) wave time-domain measuring system, for emitting a THz wave in response to the second laser pulse series, wherein the THz wave is capable of being emitted to the object to be measured and is reflected, so as to sample the reflected THz wave according to the first laser pulse series, thereby determining a second characteristic of the object to be measured.

2. The system according to claim 1, wherein the first characteristic comprises a zero point at a reference time.

3. The system according to claim 1, wherein the first laser pulse series has a first repetition rate, the second laser pulse series has a second repetition rate, and the first repetition rate and the second repetition rate are different.

4. The system according to claim 1, wherein the dual-optical comb absolute distance measuring system comprises:
a first laser module, for generating the first laser pulse series;
a second laser module, for generating the second laser pulse series;
a first optical coupler, for transmitting the second laser pulse series to the object to be measured, and transmitting the second laser pulse series reflected from the reference plane of the first optical coupler and the object to be measured;
a second optical coupler, for coupling the first laser pulse series and the second laser pulse series reflected from the reference plane of the first optical coupler and the object to be measured, so as to output a sampled time expanded laser pulse train; and
an optical detector, for detecting the asynchronously sampled laser pulse train, wherein time when the optical detector receives the second laser pulse series reflected from the reference end surface of the first optical coupler is recorded as first time, and time when the optical detector receives the second laser pulse series reflected from a surface of the object to be measured is recorded as second time.

5. The system according to claim 4, further comprising a feedback control device, for controlling the object to be measured according to the first time and the second time.

6. The system according to claim 4, wherein the first laser module and/or the second laser module is a frequency stabilized or non-frequency stabilized laser module.

7. The system according to claim 1, wherein the THz wave time-domain measuring system comprises:
a THz radiating element, for generating a THz wave in response to the second laser pulse series, so as to irradiate the object to be measured; and
a THz receiving element, for receiving and sampling the THz wave reflected from the object to be measured.

8. The system according to claim 7, wherein the THz wave is reflected to the object to be measured by a first reflecting element.

9. The system according to claim 7, wherein the THz wave reflected from the object to be measured is reflected to the THz receiving element by two first reflecting elements.

10. An object characteristic measuring method, comprising:
generating a first laser pulse series and a second laser pulse series, wherein the second laser pulse series is used to irradiate a reference plane and an object to be measured, so as to sample the reflected second laser pulse series according to the first laser pulse series, thereby accordingly determining a first characteristic of the object to be measured; and
emitting a terahertz (THz) wave in response to the second laser pulse series, wherein the THz wave is capable of being emitted to the object to be measured and is reflected, so as to sample the reflected THz wave according to the first laser pulse series, thereby determining a second characteristic of the object to be measured.

11. The method according to claim 10, wherein the first characteristic comprises a zero point at a reference time and a corresponding distance between the reference plane and a surface of the object to be measured.

12. The method according to claim 10, wherein the first laser pulse series has a first repetition rate, the second laser pulse series has a second repetition rate, and the first repetition rate and the second repetition rate are different.

13. The method according to claim 10, wherein the step of determining the first characteristic of the object to be measured comprises:
a first laser module generating the first laser pulse series;
a second laser module generating the second laser pulse series;
a first optical coupler transmitting the second laser pulse series to the object to be measured, and transmitting the second laser pulse series reflected from the reference plane of the first optical coupler and the object to be measured;
a second optical coupler coupling the first laser pulse series and the second laser pulse series reflected from the reference plane of the first optical coupler and the object to be measured, so as to output a sampled time expanded laser pulse train; and
an optical detector detecting the asynchronously sampled laser pulse train, wherein time when the optical detector receives the second laser pulse series reflected from the reference end surface of the first optical coupler is recorded as first time, and time when the optical detector receives the second laser pulse series reflected from a surface of the object to be measured is recorded as second time.

14. The method according to claim 13, further comprising controlling the object to be measured according to the first time and the second time.

15. The method according to claim 13, wherein the first laser module and/or the second laser module is a frequency stabilized or non-frequency stabilized laser module.

16. The method according to claim 10, wherein the step of determining the second characteristic of the object to be measured comprises:
a THz radiating element generating a THz wave in response to the second laser pulse series, so as to irradiate the object to be measured; and
a THz receiving element receiving and sampling the THz wave reflected from the object to be measured.

17. The method according to claim 16, wherein the THz wave is reflected to the object to be measured by a first reflecting element.

18. The method according to claim 16, wherein the THz wave reflected from the object to be measured is reflected to the THz receiving element by two first reflecting elements.
